(19) United States
(12) Patent Application Publication
(10) Pub. No.: US 2019/0258226 A1
(43) Pub. Date: Aug. 22, 2019

(54) 2D REPRESENTATIONS OF A 3D SURFACE MODEL FOR HEAT DEFORMABLE SUBSTRATES

(71) Applicant: HEWLETT-PACKARD DEVELOPMENT COMPANY, L.P., Spring, TX (US)

(72) Inventors: Josep ABAD PEIRO, Sant Cugat del Valles (ES); Raquel MARTINEZ JIMENEZ, Sant Cugat del Valles (ES)

(21) Appl. No.: 16/342,499

(22) PCT Filed: Jan. 9, 2017
(86) PCT No.: PCT/US2017/012683

§ 371 Date: Apr. 16, 2019

(51) Int. Cl. G05B 19/4099; G06T 17/30; G06T 19/20

(52) U.S. Cl. CPC G05B 19/4099; G06T 17/30; G06T 19/20; G05B 2219/49023; G06T 2219/2016; G06T 2219/2004; G06T 2219/2021

(57) ABSTRACT

An example method includes acquiring a 3D surface model at a processor. The processor may determine a plurality of differently segmented 2D representations of the 3D surface model. The processor may select, based on a predetermined 3D surface forming criteria, a segmented 2D representation of the plurality of differently segmented 2D representations for refinement. The processor may determine, based on the selected segmented 2D representation, a refined 2D representation. The refined 2D representation may be determined such that the refined 2D representation provides an output which, when formed in a heat deformable substrate, is formable to a shape of the 3D surface model with better accuracy than an output of the selected segmented 2D representation.

### BACKGROUND

In an example of a method of providing a surface, a substantially two dimensional substrate is formed to provide a three dimensional shape. Heat may be used to deform the substrate in forming the surface. For example, the substrate may be wrapped around an object. In some examples, the substrate may comprise, at least in part, a heat-deformable material such as vinyl or the like.

In some examples, the shape formed may be complex, for example including edges and/or curves.

### BRIEF DESCRIPTION OF DRAWINGS

Non-limiting examples will now be described with reference to the accompanying drawings, in which:

FIG. 1 is a flowchart of an example method of determining a 2D representation from a 3D surface model;

FIG. 2 is a schematic drawing illustrating an example of the method of FIG. 1;

FIG. 3 is a flowchart of an example method of determining and printing a 2D representation of a 3D surface model on a heat deformable substrate;

FIG. 4 shows an example processing apparatus; and

FIG. 5 shows an example of a machine readable medium in association with a processor.

### DETAILED DESCRIPTION

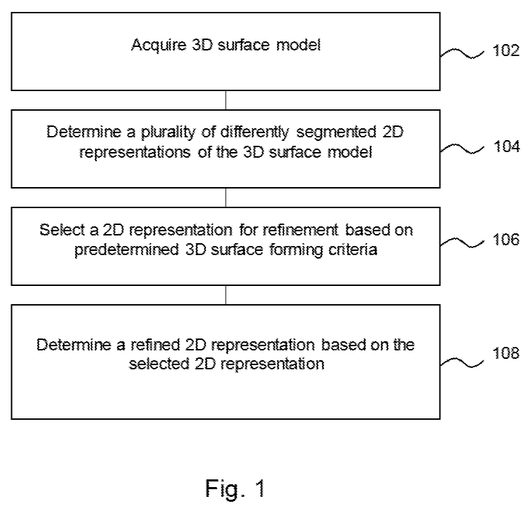

FIG. 1 is an example of a method, which may be a method of determining a 2D representation to be printed on or otherwise formed in a heat deformable substrate. In some examples, the method may be a computer implemented method. In some examples, the 2D representation is to be formed in a substantially 2D substrate to provide a 3D surface, which may in some examples include at least one of a contour, an edge, a discontinuity and the like.

For example, the 2D substrate (in some examples, when printed) may be to be applied to an object to provide a decorative effect, or a protective layer or the like. It may be intended to conform accurately to the surface, for example smoothly overlying an object surface (for example, providing a surface wrap for a car, or part thereof, or some other object). Moreover, in some examples, the substrate may be printed with an image, which may be a pattern, for example, comprising words, pictures or graphical marks. In some examples, the image may be intended to be continuous over object portions.

In forming a heat deformable substrate to provide a 3D surface, it may be the case that some features, which may disrupt the conformity of a non-deformable surface, may be effectively compensated for by applying heat. For example, substrates may be caused to stretch and/or shrink under the application of heat. However, there are practical limits to the amount of deformation which may occur, based for example on the properties of the substrate and, where the substrate is printed, the printing applied thereto. Therefore, while some mismatches between a 2D substrate (which may be a printed 2D substrate) and the 3D surface it is intended to take may be resolved in forming the surface, others may not be resolvable (or not entirely resolvable), which could result in an unsightly or ineffective surface being formed.

Block 102 comprises acquiring, at a processor, a 3D surface model. For example, this may be a model of an actual or theoretical surface about which a substrate is to be formed.

Block 104 comprises determining, by the processor, a plurality of differently segmented 2D representations of the 3D surface model. This may for example make use of an ‘unwrap’ process, which may be a computer implemented process. For example, such a process may approximate the 3D surface as one or a number of geometrical objects, for example cones, cylinders and the like (which, in some examples, may comprise ‘developable surfaces’ with a Gaussian curvature of 0) and apply a mapping from each point on the surface to a surface of the geometrical object. In some examples, each geometrical object may be unwrapped into one or a plurality of segments of the representation. The term “segment” is used herein to represent portions of the 3D surface model which are mapped to separate planes in forming a 2D representation.

It may be appreciated that, in particular when the heat deformability of the substrate is considered, there may be a number of ways of representing a 3D surface as a series of planes. For example, to consider a sphere, this can be imagined as being made up of a combination of hexagons and pentagons (each of which comprises a ‘segment’), as in a European football, but could be any form of geodesic dome. In another example, a sphere may be considered as a plurality of segments having curved edges meeting at a point at either end of the sphere, i.e. defining the surface of a wedge of the sphere. Even a standard football unwrap could be formed in a number of different ways in two dimensions, with hexagons/pentagons being linked differently in different unwrap models. If a material is sufficiently heat deformable, a sphere could be formed of just one or two planes (although this is unlikely to be sufficient for materials such as vinyl).

Therefore, the different 2D representations may represent different ‘unwraps’ of the surface.

In some examples, the segmented 2D representations may be produced according to predetermined criteria, which may be selected with a view to the likely suitability of the 2D representation to forming the 2D surface when printed on a substrate.

For example, each segment may have at least a minimum size. This may prevent the formation of, for example, thin strips which may be hard to handle or position when forming the surface.

In another example, a surface of the 3D surface model which subtends an arc of more than a predetermined size may be mapped to at least two segments. This may for example be a curved surface which curves by more than a predetermined amount. The maximum arc of a segment may be predetermined such that, from a point of origin defined by the curve of the surface, the arc subtended is at most 340°, 300° or some other predetermined value. This may prevent segments from being formed which are likely to form a ridge or pucker (or a non-resolvable ridge or pucker) when joined to other segments in forming the surface. In some examples, the number of segments formed may depend on the arc subtended, with the number of segments increasing with angle (for example at each of a series of thresholds).

In another example, the segments may be determined such that angles between segments are within predetermined criteria. Where segments meet at too wide an angle, a peak may result when forming to the surface. By ensuring that the angles are within predetermined criteria, such peaks may be reduced or avoided (for example, such that any initially formed peak is resolvable by the application of heat).

The values placed on these criteria may vary based on, for example, the material used and any printing applied thereto, as well as according to the intended effects (some use cases may allow a degree of puckering, ridges or peaks, while others may allow less, or no, such features). For example, this may be based on a material's elasticity (in some examples, in each of a plurality of axes) and/or a material's deformation characteristics (which may model, for example, an achievable stretch or contraction of a material). The values may be determined empirically for a material and intended effect and/or stored in a lookup table.

Block 106 comprises selecting, by the processor, and based on at least one predetermined 3D surface forming criteria, a segmented 2D representation of the plurality of differently segmented 2D representations for refinement. In some examples, the selection may comprise mapping each 2D segmented representation into a 3D form at least approximating the 3D surface model and assessing the representation against the 3D surface model and/or other criteria. In some examples, such mapping may be based on the anticipated behaviour of a substrate when forming the surface and/or when heat and/or force is applied thereto. In some examples, such mapping may be carried out using physical and/or behavioural characteristics of a particular substrate or substrate type (which may be the substrate to be used in forming the surface). Thus mapping each 2D segmented representation into a 3D form at least approximating the 3D surface model may comprise, in some examples, modelling at least one change to a substrate formed according to the 2D segmented representation which occur on forming the surface, for example on application of force and/or heat.

In some examples, the mapping of a 2D segmented representation into a 3D form at least approximating the 3D surface model may be determined as a data file, which may be an XML format data file, and which may specify splines and/or lines thereof. The data file may comprise metadata regarding any or any combination of textures, images, texts and colors, and/or a location within the geometry of the 3D surface to which the 2D representation will apply. In some examples, the data file may be used to generate a 3D form which is displayed to a user, for example providing a representation of the surface, and user input may be accepted, in some examples in addition to automatically applying criteria.

In other examples, rather than mapping the 2D representation into 3D, the selection may be based on criteria such as angles between segments, size of segments, image analysis and the like.

The predetermined 3D surface forming criteria may for example comprise the conformability of the 2D representation to the 3D surface model. For example, this may comprise determining the degree to which ridges, peaks, puckering and the like may be seen when the 3D surface is formed, and in some examples the resolvability of such features. As noted above, in other examples, the behaviour of the substrate when forming the surface may be included when modelling a 3D surface for the sake of comparison with the predetermined 3D surface forming criteria. In some examples, a comparison to predetermined 3D surface forming criteria may be carried out at least in part automatically based on the predetermined criteria. In some examples, a representation of the 3D surface which may be formed using a substrate formed according to the 2D representation may be generated and displayed to a user, who may indicate points of concern and/or select a 2D representation of refinement.

Another criteria which may be considered in some examples is the appearance of at least one pattern element when formed as a 3D surface (for example, a feature within an image printed thereon). For example, the continuity of lines or other patterns over non-contiguous segments may be considered. The degree by which a pattern portion may be shrunk or stretched may be a criteria, as this may impact the visual effect of the surface: excessive stretching or shrinking in a pattern/image area may be unsightly. In order to predict the behaviour of the substrate, the elasticity and/or heat deformability of the substrate may be considered. The printing process, as well as the pattern/image to be applied thereto, may be considered when determining when shrinking or stretching is excessive. In some examples, this may be determined automatically based on predetermined criteria (some printed substrates may perform differently to other depending on the materials and techniques used, some image portions may be distorted more than others without undue visual impact, etc.). In some examples, a representation of the 3D surface which may be formed using a substrate formed according to the 2D representation may be generated and the representation may be displayed to a user, who may indicate points of concern in the appearance of the object. In some examples, at least one criteria may be assessed using image processing.

Another criteria which may be considered in some examples may comprise the manageability of at least one portion of a heat deformable substrate on to which the 2D representation is applied (i.e. an output based on the 2D representation). For example, in particular where segments are isolated from other segments around a portion of their circumference, smaller segment may be hard to place manually, and may react less predictably to applied heat. This may be considered, for example, by comparing each segment size to a predetermined minimum segment size (which may for example be an area, or a dimension, such as a minimum length or width or the like).

Another criteria which may be considered in some examples may comprise scaling of a pattern/image portion. For example, a pattern printed on a vinyl material may be caused to stretch and shrink on application of heat. A printed image which is scaled at, say, 90% (or any value smaller than 100%) may allow stretching to occur, whereas an image scaled to, say, 120% (or any value greater than 100%) may allow for shrinking to occur. Generally, in forming surfaces from heat deformable materials, the materials are stretched more often than they are shrunk. However, some materials may shrink on heating, for example recovering an original form.

In some examples, at least two segmented 2D representations may be selected. For example, two, three, four or more of the ‘best’ segmented 2D representations (as determined by comparison to 3D surface forming criteria) may be selected for refinement. These may be refined individually, or may be combined in determining a refined model, as is discussed in greater detail below.

Block 108 comprises determining, by the processor and based on the selected segmented 2D representation (or in some examples, based on a plurality of differently segmented 2D representations), a refined 2D representation, wherein the refined 2D representation is determined such that the refined 2D representation provides an output which, when formed in a heat deformable substrate, is formable to a shape of the 3D surface model with better accuracy than an output of the selected segmented 2D representation(s) when formed in a heat deformable substrate. The output may for example be a printed and/or cut output formed from the heat deformable material according to the refined 2D representation.

In some examples, determining the refined 2D representation may comprise at least one of: changing at least one angle between segments (for example, to avoid or reduce peaks being formed), dividing a segment into a plurality of segments (for example, to avoid or reduce ridges being formed, or to increase manageability of large segments), merging a plurality of segments into a merged segment (for example, to resolve pattern/image discontinuities), rescaling a segment (for example, to avoid or reduce stretching and/or shrinking, or to ensure text is printed in a readable manner), enlarging or adding a segment (for example to allow a curve to close or to provide an overlap section), altering an image applied thereto (for example, to promote continuity of image features such as lines or text between segments), or reconfiguring segments. From the foregoing, it will be appreciated that image discontinuities may be resolved by reconfiguring segments and/or by altering the image that is applied to a substrate.

In some examples, determining the refined 2D representation may comprise modifying at least one aspect of a 2D representation so as to increase conformity with the 3D printing surface forming criteria. In some examples, the method of refining may be selected by determining on which 3D surface forming criteria a selected 2D representation performed relatively poorly, and altering the model to improve performance against that criteria. As mentioned above, in some examples, aspects of different selected 2D representations may be merged to result in convergence on refined representation. For example, one 2D representation may perform well over a sub-portion thereof, whereas another 2D representation may perform well over different sub-portion thereof. The sub-portions may be merged to form a refined 2D representation. In some examples, in order to achieve the refinement, the segments of a 2D representation may be rearranged into a different configuration.

For example, the 3D surface may be the surface of a car. Block 106 may comprise considering 3D surface forming criteria such as identifying areas in which forming the 3D surface will stretch the wrapping materials towards their limits. In some examples, points or corners of the 3D surface or of the 2D representation when provided as substrate formed to the 3D surface will be considered. In some examples, the arc which a segment subtends (which may be a smooth arc, or may contain edges or corners) will be considered. In some examples, angles between segments will be considered, and/or areas to be formed in the substrate which are too small for ease of handling (e.g. which have a region thinner than some threshold, such as 4 cm). A scaling to apply to an image may also be considered. In some examples, the continuity of an image feature which crosses segments and/or discontinuities in the object (for example, running across a portion of the car body and a portion of the car door) may be considered. Block 108 may comprise adding or extending a segment curve to compensate for any missing section in order to close a curve, extending in the region of points or corners to suggest a cutting pattern which provides overlapping in these areas. Areas which were identified as being too small may be enlarged (for example, by 3-5 cm, or so as to exceed a minimum threshold). Some of the image scaling may be applied in stretching the substrate rather than in applying the image to the substrate. In some examples, where a discontinuity in an image feature is seen, the image to be printed may be modified to resolve such a discontinuity.

Any, or any combination of such methods or other methods may be used in refining the 2D representation(s). The process of refining may be iterated, to provide a second or further generation of refined 2D representations. The methods and/or combinations methods of refining the 2D representation may differ in different iterations. A refined 2D representation may be formed in (in some examples being printed on) a substrate, and/or a representation of the 3D surface formed thereby may be displayed to a user. In some examples, a substrate formed according to the refined 2D representation may be formed into a 3D surface.

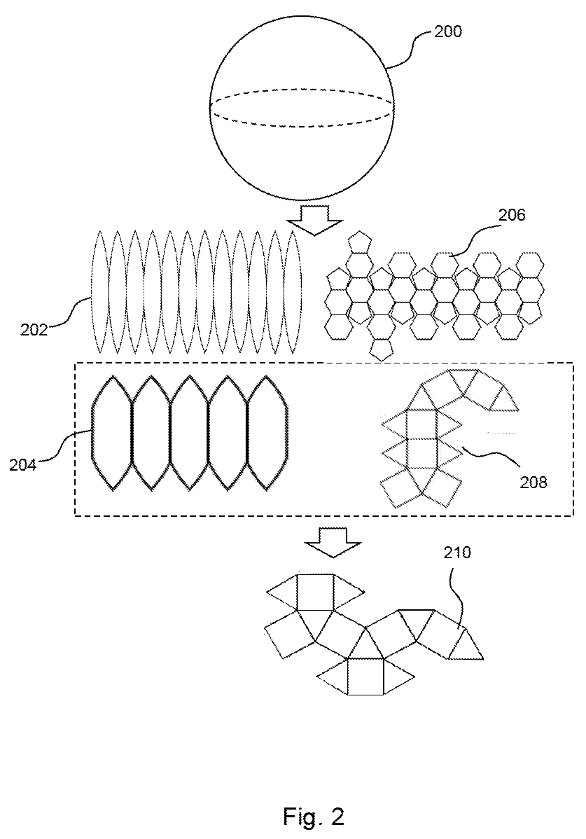

FIG. 2 shows an example of a method of determining a refined 2D representation of a 3D surface graphically.

An object, in this example, a sphere 200, provides a 3D surface model. This is unwrapped to provide a plurality of unwrap models 202, 204, 206, 208. In this example the two models which best conform to 3D surface forming criteria are selected (for example, by mapping the unwrap models into the 3D surfaces they may form using a model which includes a consideration of the physical characteristics and behaviour of the material to be used in forming the substrate, and evaluating this using one or a combination of user input and automatic comparison to predetermined 3D surface forming criteria), and aspects thereof are combined to provide a refined model 210 (which in the example of the Figure incorporates a longitudinal configuration of one of the unwrap modules and the segmentation of another of the unwrap modules). This may reduce a substrate region consumed in printing the 2D representation.

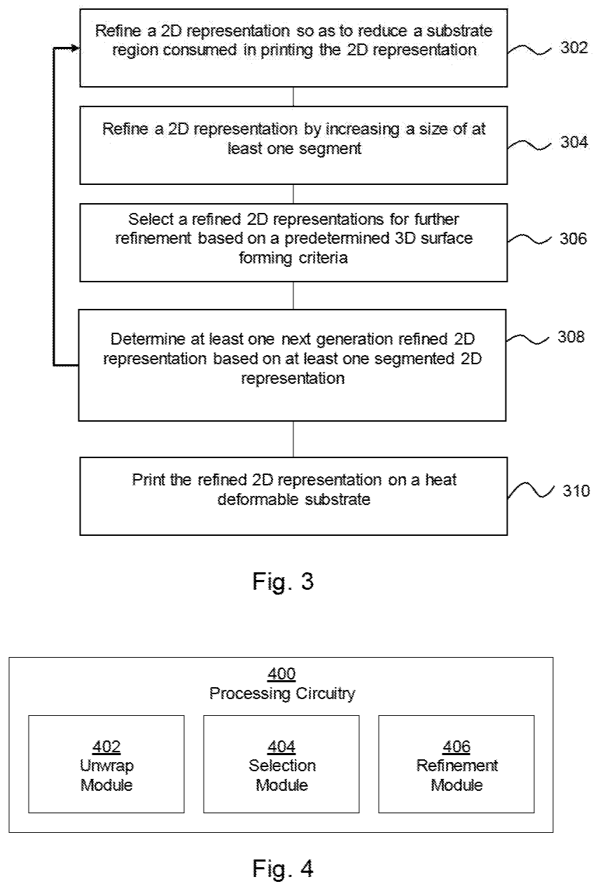

FIG. 3 shows another example of a method, which may be a method for printing a heat deformable substrate, and which may follow the method of FIG. 1.

In this example, block 302 comprises refining at least one 2D representation so as to reduce a substrate region consumed in printing the 2D representation. This may for example result in a more compact representation.

In some examples, the selection of at least one 2D representation for refinement may also take into account the amount of substrate consumed in printing the 2D representation.

Block 304 comprises refining at least one 2D representation by increasing a size of at least one segment. This may for example increase manageability of a substrate region which may be an output based on the 2D representation in use and/or may allow for an overlap in a region of a corner or point. In some examples, this may comprise adding a border region. Adding a border region may comprise providing cut marks indicative of a border around a printed design for use when cutting a 2D representation from a larger substrate sheet. In some examples, at least one alignment mark, which may for example be used by an operator when forming the surface, may be printed. In another example, at least one trimming mark may be provided. These may be used to provide a flap of material which may be pulled when forming the surface, then subsequently cut away. In other examples, a segment may be changed in size by scaling, for example such that it may be shrunk or stretched to the intended size on forming the 3D surface.

Block 306 comprises selecting, by the processor, and based on a predetermined 3D surface forming criteria, at least one of the plurality of refined 2D representations for further refinement. For example, the selection may be carried out as described in relation to block 106 above.

Block 308 comprises determining, by the processor and based on the selected at least one segmented 2D representation, at least one next generation (e.g. on the first iteration, a second generation) refined 2D representation. The next generation refined 2D representation is determined such that the next generation refined 2D representation provides an output which, when formed in a heat deformable substrate, is formable to a shape of the 3D surface model with better accuracy than an output of the selected at least one of the refined 2D representations when formed in a heat deformable substrate. This refinement method may be carried out as described in relation to block 108 above.

This process may be iterated, as shown with arrow in FIG. 2. The iteration may be carried out a predetermined number of times, or until a solution meeting at least one predetermined 3D surface forming criteria and/or user approval is met. Alternative and/or different methods of refining the 2D representation may be used in different iterations.

Block 310 comprises printing the refined 2D representation on a heat deformable substrate, for example using a print apparatus. The printing may comprise printing one or more images and/or one or more cut, alignment and/or trimming marks (which may indicate how to cut and/or apply the substrate). In other examples, instead or as well as being printed, the refined 2D representation may be formed in the substrate directly, for example by computer controlled cutting of the substrate. The printed substrate may be cut and/or applied to an object to form a 3D surface. Heat may be applied in order to form the surface, which may be carried out manually or in some cases at least in part automatically, for example under the control of robotic arms of the like.

FIG. 4 is an example of processing circuitry 400 comprising an unwrap module 402, a selection module 404 and a refinement module 406.

The unwrap module 402 generates a plurality of segmented representations of a 3D surface, each segmented representation comprising at least one plane. The plane(s) may model portions of the 3D surface (or viewed another way, portions of the 3D surface may be mapped to the planes). In some examples, the unwrap module 402 segments a model of a three dimensional object having the 3D surface into a plurality of geometric shapes and unwraps the geometrical shapes to provide a segmented representation of the 3D surface.

The selection module 404 selects a segmented representation based on a suitability of each segmented representation to form the 3D surface in a heat deformable material. In some examples, selection module 404 may select a plurality of the segmented representations in this manner. The selected segmented representation(s) may be those which are more suitable than others, or which exceed a suitability threshold or the like. The suitability may be determined using 3D surface forming criteria, for example as outlined above.

The refinement module 406 refines the selected segmented representation(s) to determine a refined segmented representation having an increased suitability to form the 3D surface in a heat deformable material. In some examples, the refinement module 406 is to merge aspects of different segmented representations to determine a refined segmented representation. In some examples, the refinement module 406 changes at least one angle between segments, divides a segment into a plurality of segments, merges a plurality of segments into a merged segment, rescales a segment, alters a shape of a segment, merges aspects of different selected 2D representations, alters an image applied thereto (for example, to promote continuity of image features such as lines or text between segments), and/or increases a size of a segment, for example by a border region which may allow for an overlap, or which may close a curve, or the like.

The processing circuitry 400 may be operable to carry out the method of FIG. 1 or FIG. 3. For example, the unwrap module 402 may be operable to carry out the method of block 104, the selection module 404 may be operable to carry out the method of block 106, and/or the refinement module 406 may be operable to carry out any of the processes described in relation to block 108, 302, 304, 306 or 308 above.

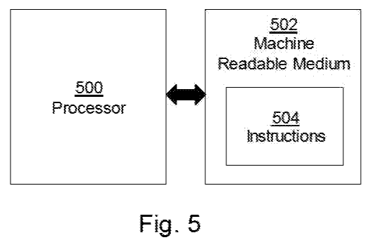

FIG. 5 is a representation of a processor 500 in association with in tangible (non-transitory) machine readable medium 502. The machine readable medium 502 comprises instructions 504 which, when executed by a processor, cause the processor to assess, from a plurality of 2D representations of a 3D surface, which representations are better suited to form the 3D surface in a heat deformable material; and to refine a 2D representation of the plurality of 2D representations to increase its suitability to form the 3D surface in the heat deformable material, wherein the suitability is determined based on at least one of the conformability to the shape of the 3D surface, the appearance of at least one pattern element when formed as a 3D surface, and the manageability of at least one portion of the heat deformable material.

In some examples, the instructions 504 to refine least one 2D representation comprise instructions which, when executed by the processor 500, cause the processor to carry out at least one of: a change at least one angle between segments of the 2D representation, division of a segment into a plurality of segments of the 2D representation, merging of a plurality of segments of the 2D representation into a merged segment, rescaling of a segment of the 2D representation, altering a shape of a segment, merging of aspects of different selected 2D representations, and enlarging or adding a segment, and/or altering an image applied thereto.

The instructions 504 may comprise instructions to carry out any of the blocks described in relation to FIG. 1 or FIG. 3. In some examples, the instructions may comprise instructions to provide at least part of the processing circuitry 400 of FIG. 4.

Examples in the present disclosure can be provided as methods, systems (hardware, firmware or the like) or machine readable instructions to be executed by processing circuitry. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted, and at least some processes may be carried out in parallel. Blocks described in relation to one flow chart may be combined with those of another flow chart. It shall be understood that at least some flows in the flow chart, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules (for example, the unwrap module 402, selection module 404 and/or the refinement module 406) of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, programmable gate array, etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
acquiring, at a processor, a 3D surface model;
determining, by the processor, a plurality of differently segmented 2D representations of the 3D surface model;
selecting, by the processor, and based on a predetermined 3D surface forming criteria, a segmented 2D representation of the plurality of differently segmented 2D representations for refinement; and
determining, by the processor and based on the selected 2D representation, a refined 2D representation, wherein the refined 2D representation is determined such that the refined 2D representation provides an output which, when formed in a heat deformable substrate, is formable to a shape of the 3D surface model with better accuracy than an output of the selected 2D representation.

2. The method according to claim 1 wherein determining, by the processor, a plurality of differently segmented 2D representations of the 3D surface model comprises determining a segmented 2D representation according to criteria comprising at least one of:
determining each segment to have at least a minimum size;
mapping a surface of the 3D surface model which subtends an arc of more than a predetermined size to at least two segments; and
determining the segments such that angles between segments are within predetermined criteria.

3. The method according to claim 1 wherein selecting a segmented 2D representations for refinement based on the predetermined 3D surface forming criteria comprises selecting a 2D representation based on at least one of:
conformability to the 3D surface model;
appearance of at least one pattern element when formed as a 3D surface; and
manageability of at least one portion of a heat deformable substrate to which the segmented 2D representation is applied.

4. The method according to claim 1 in which determining, by the processor and based on the selected 2D representation, a refined 2D representation comprises at least one of:
changing at least one angle between segments;
dividing a segment into a plurality of segments;
merging a plurality of segments into a merged segment;
altering a shape of a segment,
rescaling a segment;
reconfiguring a relative arrangement of segments;
adding a segment;
altering an image to be applied to the substrate in an output of the 2D representation; and
merging aspects of different selected 2D representations.

5. The method according to claim 1 wherein determining, by the processor and based on the selected 2D representation, a refined 2D representation comprises modifying the selected 2D representation so as to reduce a substrate region consumed in printing the 2D representation.

6. The method according to claim 5 wherein refining the selected 2D representation comprises rearranging the segments into a different configuration.

7. The method according to claim 1 comprising generating, using the processor, a representation of a 3D surface formable from a substrate output formed according to the selected 2D representation and displaying the generated a 3D surface model.

8. The method according to claim 1 comprising:
determining a plurality of refined 2D representation;
selecting, by the processor, and based on predetermined 3D surface forming criteria, a refined 2D representation of the plurality of refined 2D representations for further refinement; and
determining, by the processor and based on the selected refined 2D representation, a next generation refined 2D representation, wherein the next generation refined 2D representation is determined such that the next generation refined 2D representation provides an output which, when formed in a heat deformable substrate, is formable to a shape of the 3D surface model with better accuracy than an output of the selected refined 2D representation on which it is based.

9. The method according to claim 1 comprising printing the refined 2D representation on a heat deformable substrate.

10. Processing circuitry comprising:
an unwrap module to generate a plurality of segmented representations of a 3D surface, each segmented representation comprising at least one plane;
a selection module to select a segmented representation of the plurality of segmented representations based on a suitability of each segmented representation to form the 3D surface in a heat deformable material; and
a refinement module to refine the selected segmented representation to determine a refined segmented representation having an increased suitability to form the 3D surface in a heat deformable material.

11. The processing circuitry according to claim 10 wherein the unwrap module is to segment a model of a three dimensional object having the 3D surface into a plurality of geometric shapes and to unwrap the geometrical shapes to provide a segmented representation of the 3D surface.

12. The processing circuitry according to claim 10 wherein the refinement module is to merge aspects of different segmented representations to determine a refined segmented representation.

13. The processing circuitry according to claim 10 wherein the refinement module is to:
change at least one angle between segments;
divide a segment into a plurality of segments;
merge a plurality of segments into a merged segment;
rescale a segment;
alter a shape of a segment,
merge aspects of different selected 2D representations;
reconfigure a relative arrangement of segments;
add a segment;
alter an image to be printed on a substrate to form the 3D surface; and
increase a size of a segment.

14. A non-transitory machine readable medium comprising instructions which, when executed by a processor, cause the processor to:
assess, from a plurality of 2D representations of a 3D surface, which representations are better suited to form the 3D surface in a heat deformable material; and
refine a 2D representation of the plurality of 2D representations to increase its suitability to form the 3D surface in the heat deformable material, wherein the suitability is determined based on at least one of:
conformability to the 3D surface;
appearance of a pattern element when formed as a 3D surface; and
manageability of a portion of the heat deformable material.

15. The non-transitory machine readable medium according to claim 14 wherein the instructions to refine a 2D representation comprise instructions which, when executed by a processor, cause the processor to at least one of:
change at least one angle between segments of the 2D representation;
divide a segment into a plurality of segments of the 2D representation;
merge a plurality of segments of the 2D representation into a merged segment;
rescale a segment of the 2D representation;
alter a shape of a segment,
merge aspects of different selected 2D representations;
reconfigure a relative arrangement of segments; and
add a segment;
alter an image to be printed on a substrate to form the 3D surface; and
increase a size of a segment of the 2D representation.
